(19) United States
(12) Patent Application Publication
(10) Pub. No.: US 2019/0049360 A1
(43) Pub. Date: Feb. 14, 2019

(54) SPRAY APPLICATION OF AGROCHEMICALS

(71) Applicant: Innovative Scientific Solutions, Inc., Dayton, OH (US)

(72) Inventors: Jimmy W. Crafton, Waynesville, OH (US); Michael Lawrence, Cincinnati, OH (US); Nikolay Rogoshchenkov, Centerville, OH (US); Larry Goss, Beavercreek, OH (US)

(21) Appl. No.: 16/102,020

(22) Filed: Aug. 13, 2018

Related U.S. Application Data
(60) Provisional application No. 62/545,048, filed on Aug. 14, 2017.

(51) Int. Cl. G01N 15/14; A01M 21/04; A01M 7/00; A01C 23/04; B05B 1/08; G05D 7/06

(52) U.S. Cl. CPC G01N 15/1459; A01M 21/043; A01M 7/0096; A01C 23/042; B05B 12/126; G01N 15/1475; B05B 1/083; G05D 7/0629; A01C 23/047

(57) ABSTRACT

In a system for applying sprayed droplets from a nozzle located in an environment with changing conditions affecting droplet size, a method of controlling droplet size comprising locating a droplet size measurement system at a location downstream from an outlet of the nozzle; receiving at a processor data describing droplets measured by the droplet size measurement system; determining at the processor a measured droplet size distribution from the data; inputting the measured droplet size distribution to a control algorithm in the processor; comparing the measured droplet size distribution to a target droplet size distribution; and outputting from the control algorithm a at least one signal corresponding to a parameter of the system for effecting a change in the droplet size distribution.

### CROSS REFERENCE TO RELATED APPLICATION

This application claims the benefit of U.S. Provisional Patent Application Ser. No. 62/545,048, filed Aug. 14, 2017, entitled “AERIAL APPLICATION OF AGROCHEMICALS,” the entire disclosure of which is incorporated by reference herein.

### FIELD OF THE INVENTION

The present invention relates to monitoring a characteristic of sprayed fluids and, more particularly, to a system for monitoring and adjusting a characteristic of a sprayed agrochemical fluid during application of the fluid.

### BACKGROUND OF THE INVENTION

Sprayed application of agrochemicals, including aerial and ground sprayed applications, is important for enhanced crop production as it is a primary means of controlling pests, weeds, and diseases, and delivering growth promoters. A major disadvantage of sprayed application of agrochemicals is related to the drift of particles and droplets from the target area. Spray drift to a site other than that intended for application is a challenging problem facing applicators and manufacturers of agrochemicals. Spray droplet size, along with wind speed and direction, are key factors affecting drift.

At the root of the drift problem is the size of the spray droplets produced by the application nozzle. According to a study conducted by Zhu et al. (Zhu, H., D. L. Reichard, R. D. Fox, R. D. Brazee and H. E. Ozkan, “Simulation of drift of discrete sizes of water droplets from field sprayers”, Transactions of the ASAE, Vol. 37, No. 5, pages 1401-1407, (1994)), drift is far less likely to be a problem when spraying with droplets of 200 μm and larger in size. The same study indicates that spray droplets under 50 μm in diameter remain suspended in the air indefinitely or until they evaporate. Such drift is wasteful and represents a potential hazard to nearby crops, environment, and people. In an effort to address this problem research has been performed to produce spray nozzles with droplets large enough to mitigate drift but small enough to provide optimum crop coverage. However, in aerial applications, as airspeed increases, so does the percentage of small droplets since wind shear, along with increased turbulence, breaks up the large droplets, making control of droplet size particularly difficult as conditions of the spray environment change during the application process.

In the past, research efforts have studied the effects of various parameters, such as airspeed, nozzle design, and spray pressure, on the droplet size distribution. The tests performed in accordance with the past research efforts have typically used Phase Doppler Particle Analyzers (PDPA) or Laser Diffraction Particle Analyzers. Further, the tests were typically performed in wind tunnel or static ground-based testing with controlled chemical mixtures and well-established levels of wind shear and turbulence. Although these tests provide significant insights for the research community, they cannot accurately account for the many variables that can change from moment to moment (wind speed and direction, turbulence, etc.) or from application to application (chemical mix, upstream structures, etc.). Additionally, prior fieldable PDPA and Laser Diffraction (LD) systems may be considered to be too large, heavy, and/or expensive for widespread integration on commercially operated spray systems.

### SUMMARY OF THE INVENTION

In accordance with an aspect of the invention, in a system for applying sprayed droplets from a nozzle located in an environment with changing conditions affecting droplet size, a method of controlling droplet size is provided comprising: locating a droplet size measurement system at a location downstream from an outlet of the nozzle; receiving at a processor data describing droplets measured by the droplet size measurement system; determining at the processor a measured droplet size distribution from the data; inputting the measured droplet size distribution to a control algorithm in the processor; comparing the measured droplet size distribution to a target droplet size distribution; and outputting from the control algorithm at least one signal corresponding to a parameter of the system for effecting a change in the droplet size distribution.

The method may further include a predictive algorithm for determining system setup parameters and including, prior to a spraying operation, inputting to the predictive algorithm a plurality of pre-application parameter values including system parameter values and environmental parameter values.

The method may further include the system having parameter values that comprise one or more of nozzle type, orifice size, fluid properties, nozzle angle, and spray pressure.

The method may further include the environmental parameter values comprising one or more of a crosswind velocity, an atmospheric temperature, and an atmospheric humidity.

The method may further include applying a correction algorithm to the predictive algorithm during a spraying operation, the correction algorithm including corrective parameter values to compensate for limitations associated with detection of droplets in the spray produced by the nozzle.

The corrective parameter values may include a detection probability parameter value to correct for an increased likelihood of detecting larger droplets, a plume variation parameter value to correct for variations in droplet size distribution associated with a detection location along a spray plume produced by the nozzle, and an atomization correction parameter value to correct for additional atomization that occurs in the spray plume downstream from the detection location.

The method may further include analyzing data comprising the measured droplet size distribution at the end of a spraying operation, and changing the predictive algorithm prior to a subsequent spraying operation.

The droplet size measurement system may comprise a particle shadow imagery (PSI) system producing an image comprised of droplet shadows.

In accordance with a further aspect of the invention, in a mobile spray system mounted to a spray vehicle for applying sprayed droplets from a nozzle in a predetermined spray droplet size distribution, a method of controlling droplet size distribution is provided comprising: providing in a processor a predictive algorithm determining a predicted droplet size distribution; inputting to the predictive algorithm a plurality of pre-application parameter values to determine values for selectable system values corresponding to respective ones of the pre-application parameter values; operating the system to spray droplets from the nozzle during movement of the spray vehicle and obtaining spray distribution data corresponding to a droplet size distribution of the spray droplets; comparing the spray distribution data to the predetermined spray droplet size distribution; and changing one or more of the selectable system values to change the droplet size distribution to correspond to the predetermined spray droplet size distribution.

The method may further include the pre-application parameter values of the predictive algorithm comprising system parameter values and environmental parameter values.

The method may further include the system parameter values comprising one or more of nozzle type, orifice size, fluid properties, nozzle angle, and spray pressure.

The method may further include a flow rate through the nozzle being controlled by a pulse width modulation (PWM) duty cycle, and the system parameter values comprising a PWM duty cycle.

The method may further include the environmental parameter values comprising one or more of a vehicle speed, a crosswind velocity, an atmospheric temperature, and an atmospheric humidity.

The method may further include applying a correction algorithm to the predictive algorithm including corrective parameter values to compensate for limitations associated with detection of droplets in the spray produced by the nozzle.

The method may further include the corrective parameter values including a detection probability parameter value to correct for an increased likelihood of detecting larger droplets, and a plume variation parameter value to correct for variations in droplet size distribution associated with a detection location along a spray plume produced by the nozzle.

The method may additionally include the corrective parameter values further comprising an atomization correction parameter value to correct for additional atomization that occurs in the spray plume downstream from the detection location.

The method may further include the spray comprising an agricultural chemical mixture for treatment of a field, and the step of changing one or more of the selectable system values to change the droplet size distribution during treatment of the field.

The method may further include obtaining the spray distribution data from a droplet size imaging system.

The method may further include the droplet size imaging system comprising a particle shadow imagery (PSI) system producing an image comprised of droplet shadows.

In accordance with another aspect of the invention, an agrochemical spray system is provided for controlling a droplet size distribution of sprayed droplets from the spray system, the agrochemical spray system comprising at least one spray nozzle. A particle shadow imagery (PSI) system is mounted to the spray system adjacent to and downstream from at least one of the spray nozzles. The PSI system comprises imaging optics for imaging a focal plane located in the spray from the nozzle, a light source facing the imaging optics on an opposite side of the focal plane, a camera adjacent to the imaging optics for receiving shadow images of droplets passing through the focal plane, and a processor for receiving images from the camera and for processing the images to determine a measured droplet size distribution. The processor compares the measured droplet size distribution to a predetermined droplet size size distribution range, and an interface is provided for receiving an output from the processor processor and for effecting a change to the system when the measured droplet size distribution is outside of the predetermined droplet size distribution range.

### BRIEF DESCRIPTION OF THE DRAWINGS

While the specification concludes with claims particularly pointing out and distinctly claiming the present invention, it is believed that the present invention will be better understood from the following description in conjunction with the accompanying Drawing Figures, in which like reference numerals identify like elements, and wherein:

FIG. 1 is a schematic view of an agrochemical application system in accordance with aspects of the invention;

FIG. 2 is a schematic view illustrating droplet shadows caused by extinction of light for producing images provided to the present application system;

FIGS. 3A and 3B illustrate raw and processed images, respectively, produced by a Particle Shadow Imagery (PSI) system for processing and determining droplet size distribution in the present application system;

FIG. 4 is a perspective view illustrating a sensor of the agrochemical application system mounted to an aircraft;

FIG. 5 is an enlarged perspective view of the agrochemical application system shown in FIG. 4; and

FIG. 6 is a conceptual outline of a control algorithm used in the agrochemical application system for controlling droplet size in real time.

### DETAILED DESCRIPTION OF THE INVENTION

In the following detailed description of the preferred embodiment, reference is made to the accompanying drawings that form a part hereof, and in which is shown by way of illustration, and not by way of limitation, a specific preferred embodiment in which the invention may be practiced. It is to be understood that other embodiments may be utilized and that changes may be made without departing from the spirit and scope of the present invention.

In accordance with an aspect of the invention, two major obstacles are identified that must be overcome to address the issue of droplet drift. First, a cost effective sensor capable of field deployment on a wide range of agricultural spray aircraft and ground sprayers is needed to measure the droplet size distribution in real time. Second, when the droplet size distribution is determined to be outside a desired target droplet size distribution range, changes must be identified and made to the system to bring the droplet size distribution into the desired droplet size distribution range.

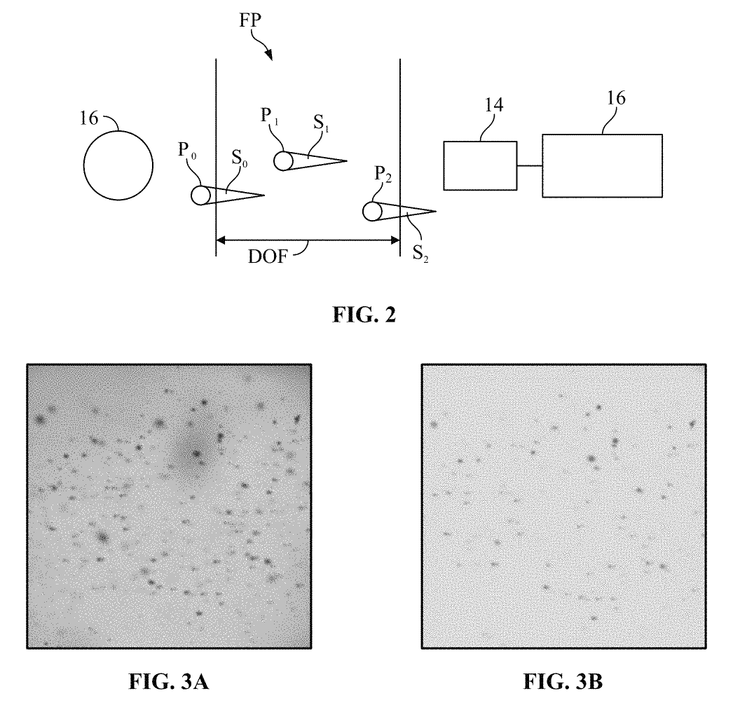

In accordance with aspects of the presently described system, a droplet size measurement system is implemented to provide real time data and adjustment of droplet size distribution to maintain the droplet size distribution within a target droplet size range. The droplet size measurement system may comprise a sensor based on Particle Shadow Imagery (PSI). Generally, in a PSI system such as is implemented herein, a light source directs light through a fluid flow to an image detecting system and in doing so, the droplets within the fluid flow cause portions of the light to be blocked from passing to the image detecting system. In other words, the individual droplets cast shadows to the image detecting system to form droplet shadow images at a camera, comprising shadows caused by extinction of the light as a consequence of absorption and scattering characteristics, e.g., see shadows S₀, S₁ and S₂ produced by droplets P₀, P₁, and P₂ and lying within the depth-of-field DOF of a focal plane FP in FIG. 2. The shadows are imaged to the camera by a lens, or system of lenses, that define an image or focal plane in a region of the fluid flow. A PSI system applicable to the present application is described in U.S. Patent Application Publication 2006/0175561, which is incorporated in its entirety by reference herein. However, it should be noted that in accordance with alternative aspects of the present disclosure other droplet size measurement systems may be implemented for providing information to determine a droplet size distribution from the spray apparatus.

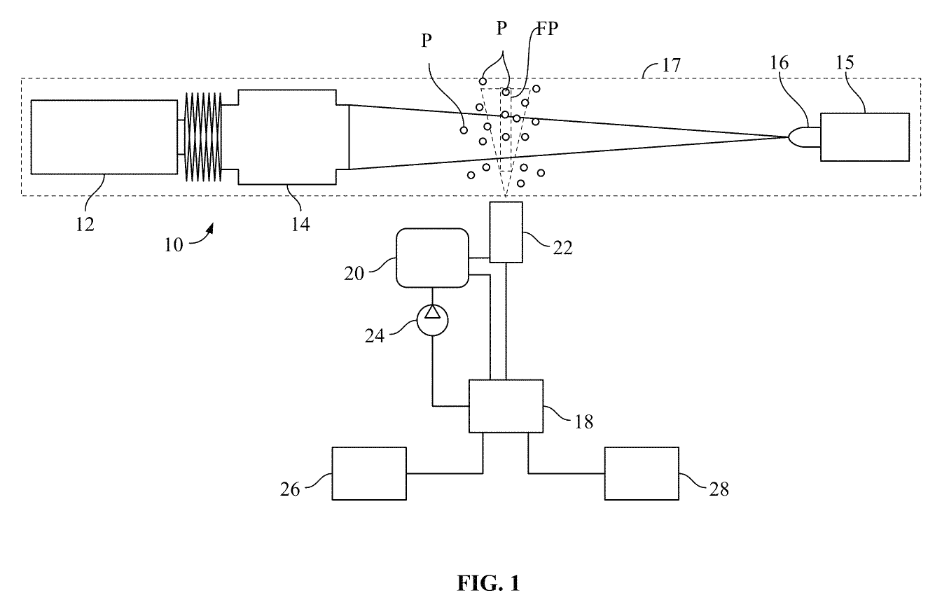

Referring to FIG. 1, a particular system 10 that can be used in agrochemical applications can include a CCD or CMOS camera 12, a lens or lens system 14 with high magnification, a light source comprising a pulse generator 15 and a pulsed LED 16, and a data acquisition/processing computer (controller/processor) 18. The camera 12, lens system 14, pulse generator 15, and pulsed LED 16 in association can define a spray droplet imaging sensor 17 for the system 10. In an exemplary embodiment, the LED 16 may comprise a 1 Watt LED and the pulse generator 15 may provide pulses to energize the LED 16 having an approximately 1 μs pulse width at approximately 50 kHz repetition rate. However, it may be understood that other repetition rates may be selected depending, for example, on system and environment requirements.

The system 10 can further include a tank 20 for supplying a fluid, such as an agrochemical, to a nozzle 22, wherein it may be understood that the tank 20 may supply fluid to a plurality of nozzles 22 located along a boom. The tank 20 can be maintained at a selected pressure by a pressurizer element, such as a pump 24 controlled by the controller 18. The size of spray droplets sprayed from the nozzle 22 is a function of the pressure in the tank 20, and the controller 18 can monitor and control the size of the spray droplets by maintaining and/or changing the pressure in the tank 20. In particular, the controller 18 can receive, filter, and process signals or images (see FIGS. 3A and 3B) produced as a result of spray droplets P from the nozzle 22 (see also P₀, P₁, P₂ in FIG. 2) passing through the focal plane FP between the camera/lens system 12, 14 and the LED 16, extinguishing the light, and appearing as shadows S₀, S₁, S₂ on the camera sensor. The optics of the lens system 14 will determine the depth of field DOF (FIG. 2) and field-of-view. In an exemplary embodiment, the field of view may be circular with a diameter of approximately 25 mm. It may be noted that in alternative embodiments, the system may be configured with a smaller field of view, such as a field of view having a diameter of approximately 12.5 mm.

A plurality of shadow images, see FIG. 3A, can be acquired at predetermined time intervals and, using known digital image processing techniques, the shadow images can be filtered, see FIG. 3B, and the shadows can be sized and counted over the several images to create a droplet size distribution. Subsequently, the droplet size distribution can be compared to a predetermined or desired range for the droplet size distribution to determine if a change to the application system needs to be implemented, as is described further below.

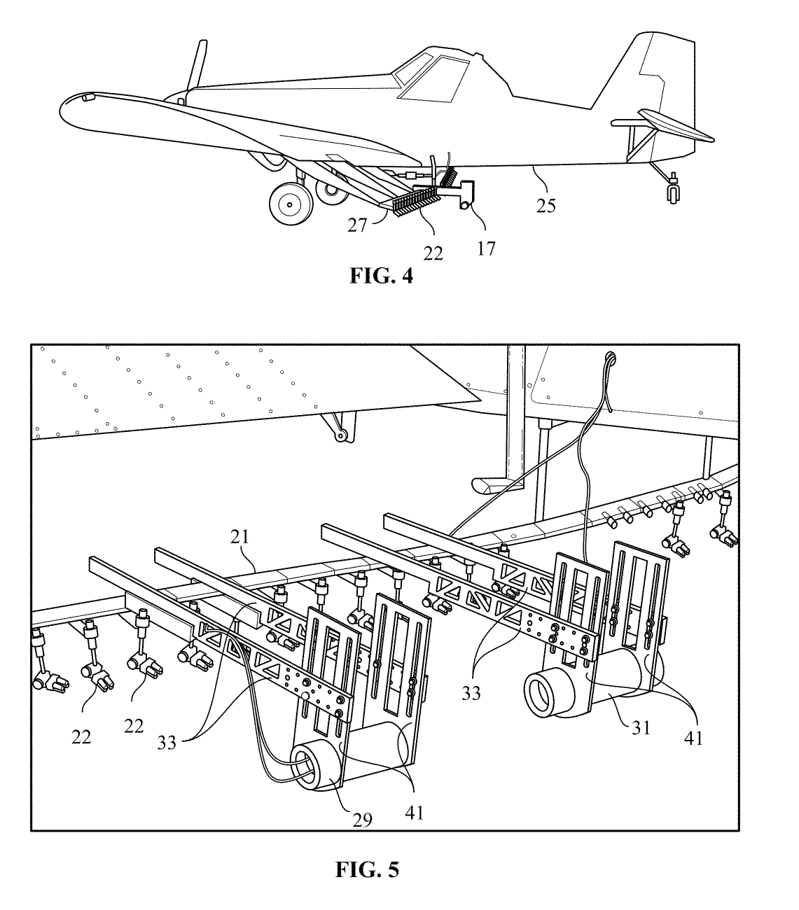

The spray imaging sensor 17 described above, e.g., the PSI sensor, is small, lightweight, robust, and relatively inexpensive, compared to the large PDPA and LD systems traditionally used for these measurements. Referring to FIGS. 4 and 5, an exemplary sensor 17 is shown installed adjacent to a trailing edge of an aircraft 25, downstream from a row 27 of spray nozzles 22. Specifically, in an exemplary embodiment, the camera/lens system 12, 14 may be mounted in a camera enclosure 29 and the LED 16 (and optionally pulse generator 15) may be mounted in an LED enclosure 31. The camera enclosure 29 and LED enclosure 31 can be supported to a spray boom 21 by lightweight struts 33 positioning the enclosures 29, 31 behind the spray nozzles 22, and may include support brackets 41 movably mounted to the struts 33 for vertical adjustment of the enclosures 29, 31.

The nozzles 22 may comprise pulse width modulation (PWM) nozzles that can be controlled by the controller 18 to open and close at a selected frequency to facilitate control of the droplet size. The duty cycle, i.e., percentage of time that the nozzle 22 is open, can be adjusted to maintain a particular spray pressure while varying the flow rate. In particular, controller 18 can operate to instruct an operator to: 1) adjust the pump pressure to change the spray pressure and droplet size, and 2) change the PWM cycle to maintain a desired chemical flow rate. Alternatively, in a closed-loop control, the controller 18 could automatically make one or more adjustments to the system.

As may be understood from the above disclosure, an obstacle to addressing spray drift can be overcome with the PSI sensor provided as the imaging sensor 17. In particular, the PSI sensor provides applicators with a cost-effective means of measuring droplet size in real time. However, as may also be understood from the above description of problems associated with application of agrochemicals, and particularly in-field operation of agrochemical sprayers, simply having information on spray droplet size does not necessarily reduce spray drift since spray conditions can be dependent upon multiple variables that may change during the application process.

In accordance with an aspect of the present description, the applicator system can include implementing a change to the applicator system in order to obtain a predetermined or desired droplet size when the droplet size distribution is determined to be outside of a target droplet size distribution range. In order to control the droplet size in real time, the controller 18 may operate with a spray optimization algorithm, or control algorithm, that can be used in conjunction with the imaging sensor 17, e.g., the PSI sensor or other imaging sensor. The controller 18 incorporating the control algorithm can integrate various environmental and operational data, as represented by element 26 in FIG. 1, with the measured size distribution to to provide real time recommendations to the operator to optimize the spray size. The output of the controller 18 providing real time recommendations to the operator is represented by element 28 in FIG. 1, and can comprise any type of output(s) for conveying information to an operator via an operator interface, e.g., a display located in an aircraft cockpit, for implementing a change in spray droplet size. For instance, the system may recommend that an aerial operator change their airspeed or spray pressure if data provided from the spray imaging sensor 17, e.g., the PSI sensor, detects a droplet size distribution outside of the target range. In addition, the system could recommend a nozzle configuration to the operator before flight to ensure that a particular target droplet size, or range of droplet sizes, is achievable by the nozzle 22 installed on the system 10.

Initially, a baseline or predictive algorithm may be provided to the operator wherein the predictive algorithm can be created from tests determining the effects of various parameters, such as nozzle type, orifice size, chemical mixture, nozzle angle, airspeed, spray pressure, PWM duty cycle, crosswind velocity, atmospheric temperature, atmospheric humidity, etc., on the droplet size distribution. A predictive algorithm for an aerial application can be represented by the following spray statistic equation:

$$Spray Statistic = {AX}_{Nozzle Type} + {BX}_{Orifice Size} + {CX}_{Chemical Mixture} + {DX}_{Nozzle Angle} + {EX}_{Airspeed} + {FX}_{Spray Pressure} + {GX}_{PWM Duty cycle} + {HX}_{Crosswind Velocity} + {IX}_{Atm . Temp .} + {JIX}_{Atm . Humidity} + K$$

where X_{[ ]} is a normalized input variable, and A to K are constants that are initially determined by preliminary experimentation, and are subsequently updated as data is collected during use of the device. Additional pre-application inputs could be provided such as, for example, aircraft type and sprayer type.

It may be understood that the spray imaging sensor 17 can output raw data for processing and determining the droplet size distribution. However, corrections will typically be required to provide an accurate distribution. First, the results can be adjusted to account for the probability of detecting different sized droplets. For example, larger droplets are generally more likely to be detected due to a higher signal-to-noise ratio. However, this effect is somewhat mitigated since large droplets are also more likely to be cut off by the edge of the image. Second, the results can be adjusted for the measurement location, e.g., the location of the focal plane for imaging the spray droplets, relative to the spray plume formed by the nozzle(s). Due to limitations on the length of the device and the size of the measurement region, the sensor can only size droplets within a small portion of the spray before full atomization occurs. Hence, further corrections can be made to account for variations within the spray plume and to account for additional atomization that may occur downstream of the droplet measurement location. The correction can take the form of the following equation:

Adjusted Spray Statistic=(Original Spray Statistic)(AX_{Detection Probability}+BX_{Plume Variation}+CX_{Atomization Correction})

where X_{[ ]} is a normalized input variable based on the spray conditions, and A to C are constants. The normalized input variables for the adjusted spray statistic can be determined in wind tunnel tests, and will vary depending on nozzle type, nozzle angle, orifice size, spray pressure, and airspeed. Further, and as noted previously, it is desirable to have spray particles of 200 μm or larger, and that spray particles under 50 μm or smaller can remain suspended in the air indefinitely. Hence, the final term in the adjusted spray statistic, i.e., CX_{Atomization Correction}, is considered important to compensate in the adjusted spray statistic for atomization that may result in spray particles under 50 μm.

Hence the spray statistic can be configured to automatically update itself as the operator uses the system and provides it with additional data, or as data from a plurality of operators may be input into the system, i.e., through input element 26, thus improving the performance of the system with time.

In an alternative configuration of the system, a closed-loop control of the nozzle 22 may be provided, such as being provided in addition to the real time operator recommendation output 28. For example, the controller 18 may operate in a closed-loop to determine a pressure change required to change the droplet size and may operate the pump 24 to change the tank pressure in order to obtain a controller determined pressure that can be sensed from a pressure sensor (not shown) in the tank 20.

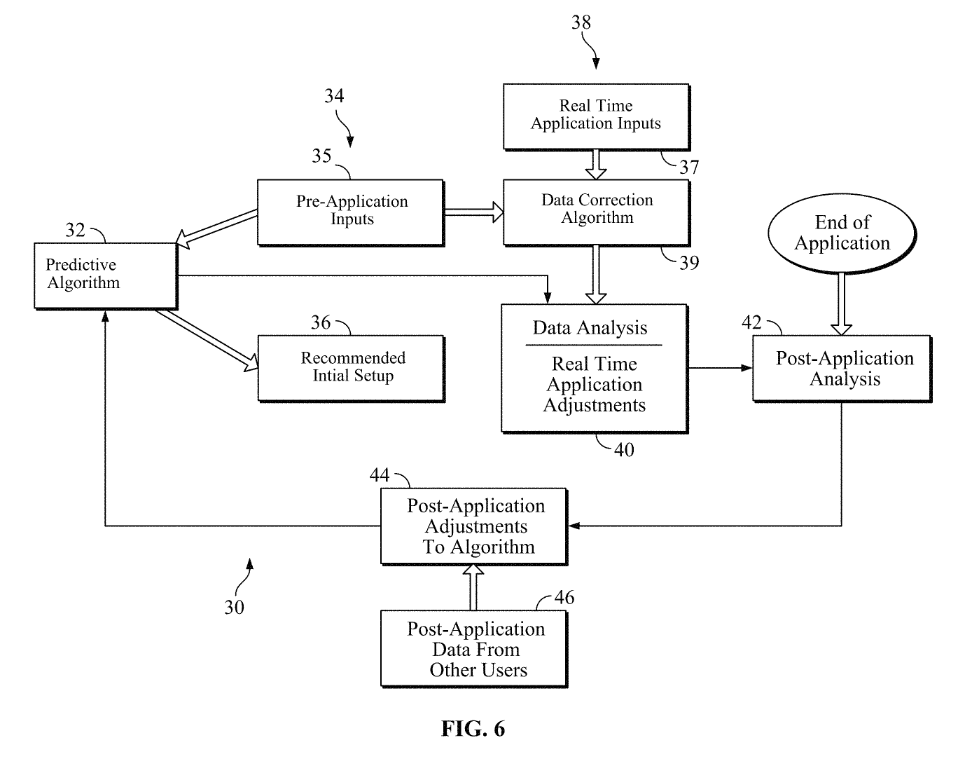

Referring to FIG. 6, a conceptual outline of a control algorithm 30 for controlling droplet size in real time, i.e., during in-field operation of the system 10, to apply an agrochemical, is shown. It may be noted that the following control algorithm 30 may be implemented with any droplet size measurement system as an input to provide a droplet size distribution.

The control algorithm 30 can be initially loaded with a baseline or predictive algorithm 32 which, as described above, may include initial correlations to correlate the droplet size to one or more of nozzle type, orifice size, chemical mixture (agrochemical mix), nozzle angle, airspeed, spray pressure, PWM duty cycle, crosswind velocity, atmospheric temperature, and atmospheric humidity. Further, in a pre-application stage 34 of using the control algorithm 30, pre-application inputs 35 may be provided by an operator to the predictive algorithm 32 including providing current values for the terms forming the predictive algorithm. Based on the pre-application input 35, the predictive algorithm 32 can provide system recommendations 36 for an initial setup of the system 10. The system recommendations 36 can include recommendations for changes to operator controlled aspects of the system 10 such as a recommended nozzle configuration, target aircraft airspeed, and target spray pressure for providing a target droplet size. During application of the agrochemical at 38, the control algorithm 30 can receive real time sensed operational or application inputs 37 including, without limitation, aircraft airspeed, aircraft heading, aircraft altitude, crosswind velocity, spray pressure, and droplet size distribution as determined from data received from a droplet size measurement system, such as a droplet image sensor 17 described by the PSI sensor. The application inputs 37 and a data correction algorithm 39, as described above, can be provided to a comparison step 40 where the control algorithm 30 can compare the current droplet size distribution to the target size distribution, including determining an adjusted spray statistic as described above. The control algorithm 30 can then implement the predictive algorithm 32, as adjusted by the data correction algorithm 39, to provide recommended corrections to the spray operation, including providing the operator with recommended corrective actions that may include recommended changes in the airspeed, airspeed, spray pressure, and/or nozzle angle, enabling real-time corrections to the agrochemical application prior to completion of the spray application process. It should be understood that the data correction algorithm 39 applied at step 40 is configured with reference to the pre-application inputs 35, such that the data correction algorithm 39 is adjusted for the particular operating conditions, as defined by parameters associated with the pre-application inputs 35.

Following the application process (end of application), a report can be generated through a post-application analysis 42 providing information on the spray performance relative to the target. The results of the post-application analysis 42 can then be used to provide recommendations for improvements to the system configuration for future spray applications under similar conditions. The results of the post-application analysis 42, i.e., based on the in-flight information from the application process, can also be used in a step 44 of adapting or refining the control algorithm 30, including refinements to the predictive algorithm 32. Additionally, the control algorithm 30 can be refined based on data received from other operators. For example, data from multiple operators may be accumulated into a centralized database and used for updating and/or improving the control algorithm 30 for use by multiple operators. Hence, each in-field spray operation can be provided as an input to improve the control algorithm 30, and in particular to refine the predictive algorithm 32 for providing a recommended initial setup 36 prior to a spray operation.

Although the preceding description describes an algorithm having multiple inputs to be used in controlling the spray droplet size distribution, in accordance with alternative aspects of the system, a known image processing comparison may be implemented to compare a sensed droplet size or droplet size distribution from data provided from the imaging sensor 17 to a desired or predetermined droplet size or droplet size distribution. In the event that the comparison indicates that a change in droplet size is desirable, a recommendation may be provided to the operator during operation of the aircraft, such as via a display in the cockpit, to change the airspeed and/or spray pressure of agrochemical mix supplied from the tank 20 to effect a mid-application change in spray droplet size, and the operator may change a setting from within the cockpit, such as to effect the change in spray pressure.

Also, this alternative aspect of the invention may be implemented in a ground based agricultural spray system. For example, a ground-based spray system can include a spray boom supporting one or more spray nozzles receiving an agrochemical mix at a selected pressure to produce a spray having droplets with a predetermined size or size distribution, as controlled by the spray pressure and selected nozzle configuration. The ground-based spray system may be a tractor powered spray system capable of traveling through a field, or may be a stationary spray system such as may be permanently or semi-permanently mounted in a fixed location to spray, for example, orchards, vineyards, or in greenhouses. The system 10 can be mounted on the ground based spray system including providing the imaging sensor 17, e.g., the PSI sensor, mounted to the spray boom with the focal plane positioned for detecting the spray from at least one nozzle Although the droplet size distribution is not affected by airspeed, as in aerial sprayers, control of droplet size distribution in real time is still desirable in ground based spray systems in order to ensure that appropriate coverage of the sprayed agrochemical mix is provided while preventing or minimizing overspray and drift as environmental conditions vary. Such real time control of the droplet size distribution could be implemented through recommendations to the operator or through a closed loop system, as in the above-described aerial sprayer, to adjust the droplet size through changes in the spray pressure.

In a further alternative aspect, the spray system may be implemented with unmanned (UAV) aircraft. In UAV applications, closed loop control may typically be implemented to change system parameters. However, system control in UAV applications could also be implemented through feedback to an operator.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. In a system for applying sprayed droplets from a nozzle located in an environment with changing conditions affecting droplet size, a method of controlling droplet size comprising:
locating a droplet size measurement system at a location downstream from an outlet of the nozzle;
receiving at a processor data describing droplets measured by the droplet size measurement system;
determining at the processor a measured droplet size distribution from the data;
inputting the measured droplet size distribution to a control algorithm in the processor;
comparing the measured droplet size distribution to a target droplet size distribution; and
outputting from the control algorithm at least one signal corresponding to a parameter of the system for effecting a change in the droplet size distribution.

2. The method as set forth in claim 1, wherein the control algorithm includes a predictive algorithm for determining system setup parameters and including, prior to a spraying operation, inputting to the predictive algorithm a plurality of pre-application parameter values including system parameter values and environmental parameter values.

3. The method as set forth in claim 2, wherein the system parameter values comprise one or more of nozzle type, orifice size, fluid properties, nozzle angle, and spray pressure.

4. The method as set forth in claim 2, wherein the environmental parameter values comprise one or more of a crosswind velocity, an atmospheric temperature, and an atmospheric humidity.

5. The method as set forth in claim 2, including applying a correction algorithm to the predictive algorithm during a spraying operation, the correction algorithm including corrective parameter values to compensate for limitations associated with detection of droplets in the spray produced by the nozzle.

6. The method as set forth in claim 5, wherein the corrective parameter values include a detection probability parameter value to correct for an increased likelihood of detecting larger droplets, a plume variation parameter value to correct for variations in droplet size distribution associated with a detection location along a spray plume produced by the nozzle, and an atomization correction parameter value to correct for additional atomization that occurs in the spray plume downstream from the detection location.

7. The method as set forth in claim 2, including analyzing data comprising the measured droplet size distribution at the end of a spraying operation, and changing the predictive algorithm prior to a subsequent spraying operation.

8. The method as set forth in claim 7, wherein the droplet size measurement system comprises a particle shadow imagery (PSI) system producing an image comprised of droplet shadows.

9. In a mobile spray system mounted to a spray vehicle for applying sprayed droplets from a nozzle in a predetermined spray droplet size distribution, a method of controlling droplet size distribution comprising:
providing in a processor a predictive algorithm determining a predicted droplet size distribution;
inputting to the predictive algorithm a plurality of pre-application parameter values to determine values for selectable system values corresponding to respective ones of the pre-application parameter values;
operating the system to spray droplets from the nozzle during movement of the spray vehicle and obtaining spray distribution data corresponding to a droplet size distribution of the spray droplets;
comparing the spray distribution data to the predetermined spray droplet size distribution; and
changing one or more of the selectable system values to change the droplet size distribution to correspond to the predetermined spray droplet size distribution.

10. The method as set forth in claim 9, wherein the pre-application parameter values of the predictive algorithm comprise system parameter values and environmental parameter values.

11. The method as set forth in claim 10, wherein the system parameter values comprise one or more of nozzle type, orifice size, fluid properties, nozzle angle, and spray pressure.

12. The method as set forth in claim 11, wherein a flow rate through the nozzle is controlled by a pulse width modulation (PWM) duty cycle, and the system parameter values comprise a PWM duty cycle.

13. The method as set forth in claim 10, wherein the environmental parameter values comprise one or more of a vehicle speed, a crosswind velocity, an atmospheric temperature, and an atmospheric humidity.

14. The method as set forth in claim 10, including applying a correction algorithm to the predictive algorithm including corrective parameter values to compensate for limitations associated with detection of droplets in the spray produced by the nozzle.

15. The method as set forth in claim 14, wherein the corrective parameter values include a detection probability parameter value to correct for an increased likelihood of detecting larger droplets, and a plume variation parameter value to correct for variations in droplet size distribution associated with a detection location along a spray plume produced by the nozzle.

16. The method as set forth in claim 15, wherein the corrective parameter values further include an atomization correction parameter value to correct for additional atomization that occurs in the spray plume downstream from the detection location.

17. The method as set forth in claim 9, wherein the spray comprises an agricultural chemical mixture for treatment of a field, and the step of changing one or more of the selectable system values to change the droplet size distribution is performed during treatment of the field.

18. The method as set forth in claim 9, wherein spray distribution data is obtained from a droplet size imaging system.

19. The method as set forth in claim 18, wherein the droplet size imaging system is a particle shadow imagery (PSI) system producing an image comprised of droplet shadows.

20. An agrochemical spray system for controlling a droplet size distribution of sprayed droplets from the spray system, the agrochemical spray system comprising:
at least one spray nozzle;
a particle shadow imagery (PSI) system mounted to the spray system adjacent to and downstream from at least one of the spray nozzles, the PSI system comprising:
imaging optics for imaging a focal plane located in the spray from the nozzle;
a light source facing the imaging optics on an opposite side of the focal plane;
a camera adjacent to the imaging optics for receiving shadow images of droplets passing through the focal plane; and
a processor for receiving images from the camera and for processing the images to determine a measured droplet size distribution, the processor comparing the measured droplet size distribution to a predetermined droplet size distribution range; and
an interface for receiving an output from the processor and for effecting a change to the system when the measured droplet size distribution is outside of the predetermined droplet size distribution range.
